(19) United States
(12) Patent Application Publication
(10) Pub. No.: US 2026/0036221 A1
(43) Pub. Date: Feb. 5, 2026

(54) MOUNTING METHOD FOR SEA OUTFALL PIPELINE IN SHALLOW SECTION

(71) Applicants: CCCC THIRD HARBOR ENGINEERING CO., LTD., Shanghai (CN); CCC third Harbor Bureau No.6 Engineering (Xiamen) Co., Ltd, Xiamen (CN); Xiamen Branch of CCCC third Harbor Engineering Bureau Co., Ltd, Xiamen (CN)

(72) Inventors: Hongwei XUE, Xiamen (CN); Junjie WANG, Xiamen (CN); Fangming TANG, Xiamen (CN); Shuiping LU, Xiamen (CN); Xiao CHANG, Xiamen (CN); Jianyang HUANG, Xiamen (CN); Xiao LIN, Xiamen (CN)

(73) Assignees: CCCC THIRD HARBOR ENGINEERING CO., LTD., Shanghai (CN); CCCC third Harbor Bureau No.6 Engineering (Xiamen) Co., Ltd, Xiamen (CN); Xiamen Branch of CCCC third Harbor Engineering Bureau Co., Ltd, Xiamen (CN)

(21) Appl. No.: 19/358,719

(22) Filed: Oct. 15, 2025

Related U.S. Application Data
(63) Continuation of application No. PCT/CN2024/081610, filed on Mar. 14, 2024.

(30) Foreign Application Priority Data
Oct. 24, 2023 (CN) 202311386479.2

(51) Int. Cl. F16L 1/235; F16L 1/26

(52) U.S. Cl. CPC F16L 1/235; F16L 1/26

(57) ABSTRACT

Disclosed is a mounting method for a sea outfall pipeline in a shallow section, including a preparation process and a construction process. The preparation process includes a pipeline pre-submergence preparation step and a pontoon apparatus positioning step. At the pipeline pre-submergence preparation step, a female flange and a male flange are welded in one-to-one correspondence at two ends of a pipeline section, blind flanges are fixed to outer ends of the female flange and the male flange respectively. At the pontoon apparatus positioning step, from front to back, a first pontoon apparatus to a fourth pontoon apparatus are sequentially anchored and positioned at a certain spacing, the first pontoon apparatus and the fourth pontoon apparatus are used in one-to-one correspondence for dismounting the blind flanges at the two ends of the pipeline section, the second pontoon apparatus and the third pontoon apparatus are used for mounting the pipeline section.

### CROSS-REFERENCE TO RELATED APPLICATIONS

The application claims priority to Chinese patent application No. 202311386479.2, filed on Oct. 24, 2023, the entire contents of which are incorporated herein by reference.

### TECHNICAL FIELD

This disclosure relates to a mounting method for a sea outfall pipeline in a shallow section.

### BACKGROUND

Bay sewage discharge is a type of sewage discharge where the sewage outfall is located in the bay and the sewage is discharged into the sea. Currently, sewage sea outfall pipelines are gradually developing from shallow seas to deep seas. Generally, for deep-sea sewage discharge pipelines, the mounting mileage is long, and the mounting technique is quite difficult.

The sea outfall pipeline led from the sewage treatment plant is composed of a pipeline in the land area section and a pipeline in the sea area section. The pipeline in the land area section is buried on land to the coast and then connected to the pipeline in the sea area section via a pipeline in the shallow section. The pipeline in the shallow section is mounted in shallow water regions near the shore, and the shallow section is generally long. In addition, the shallow section is inaccessible to ships at low tide, and pipeline submergence and mounting construction need to be carried out during high tide, which results in a short available window period and requires high control over the construction. Therefore, it is necessary to design an unconventional ship machinery device for mounting the sea outfall pipeline in the shallow section and to research corresponding mounting methods.

### SUMMARY

To overcome the defects in the prior art, the purpose of this disclosure is to provide a mounting method for a sea outfall pipeline in a shallow section, which uses four specially-made pontoon apparatuses to mount a pipeline section within a pre-excavated foundation trench in the shallows and can effectively solve the difficulty in mounting the sea outfall pipeline in a long-distance shallow section.

The purpose of this disclosure is implemented as follows: a mounting method for a sea outfall pipeline in a shallow section, where four pontoon apparatuses are used for assembling a plurality of pipeline sections into the sea outfall pipeline in the shallow section in a pre-excavated foundation trench in the shallow section; and
each of the pontoon apparatuses includes two pontoon bodies, a hoisting support, a spreader, two traction winches, a gangplank, two front anchor windlasses, and two rear anchor windlasses, where
the two pontoon bodies are disposed in parallel at a spacing greater than a diameter of the sea outfall pipeline, so that there is a pipeline channel between the two pontoon bodies;
the hoisting support includes two steel columns, two cross beams, and two longitudinal beams; the two steel columns are fixed in one-to-one correspondence to the middles of top surfaces of the two pontoon bodies; the two cross beams are connected across top surfaces of the two steel columns in a spaced manner; and the two longitudinal beams are connected across the middles of top surfaces of the two cross beams, and a spacing between the two longitudinal beams is adapted to the diameter of the sea outfall pipeline;
the spreader includes two sets of sheave blocks, two hoisting winches, and one hoisting steel wire rope; fixed pulleys of the two sets of sheave blocks are suspended in one-to-one correspondence on the middles of bottom surfaces of the two longitudinal beams of the hoisting support respectively through upper hooks above the fixed pulleys; the two hoisting winches are mounted in one-to-one correspondence on the top surfaces of the two pontoon bodies, and free ends of steel wire ropes on the two hoisting winches are connected in one-to-one correspondence to free ends of ropes wound on the two sets of sheave blocks; and two ends of the hoisting steel wire rope are connected in one-to-one correspondence to lower hooks below movable pulleys of the two sets of sheave blocks;
the two traction winches are mounted in one-to-one correspondence on rear top surfaces of the two pontoon bodies;
the gangplank is connected across the rear top surfaces of the two pontoon bodies;
the two front anchor windlasses are mounted in one-to-one correspondence on front top surfaces of the two pontoon bodies and are connected in one-to-one correspondence to two front anchors; and
the two rear anchor windlasses are mounted in one-to-one correspondence on the rear top surfaces of the two pontoon bodies and are connected in one-to-one correspondence to two rear anchors; and
the mounting method for a sea outfall pipeline in a shallow section of this disclosure includes a preparation process and a construction process;
the preparation process includes a pipeline pre-submergence preparation step and a pontoon apparatus positioning step;
the pipeline pre-submergence preparation step performs and includes the following working procedures in a pipeline assembling site:
working procedure 1: a male flange and a female flange are fixed in one-to-one correspondence at a pipeline head and a pipeline tail of each pipeline section; a convex-ridge ring extends radially from an outer end surface of a docked end of the male flange with the female flange; a connection plate extends radially from an outer circumferential surface of a docked end of the female flange with the male flange, and a plurality of connection holes are radially and uniformly distributed on a surface of the connection plate; and after a tenon of the male flange is inserted into a tenon groove of the female flange, the male flange and the female flange are fastened through a flange ring disposed on a rear end surface of the convex-ridge ring and a plurality of sets of bolt assemblies disposed in one-to-one correspondence between a plurality of bolt holes on the flange ring and the plurality of connection holes on the connection plate;
working procedure 2: a blind flange is mounted on an outer end surface of the female flange of each pipeline section, and a blind flange is also mounted on an outer end surface of the male flange of each pipeline section through the flange ring;
working procedure 3: a manhole is formed at a position, close to the flange, of a seaward end of each pipeline section, and a manhole sealing plate is used for sealing the manhole; and
working procedure 4: a first rope loop to a sixth rope loop are tied to each pipeline section along a length direction, the first rope loop is close to a rear end of a first pontoon apparatus, the second rope loop and the third rope loop are close to a front end and a rear end of a second pontoon apparatus in one-to-one correspondence, the fourth rope loop and the fifth rope loop are close to a front end and a rear end of a third pontoon apparatus in one-to-one correspondence, and the sixth rope loop is close to a front end of a fourth pontoon apparatus; and finally, three strands of traction ropes are tied on each pipeline section, each strand of traction ropes is composed of two traction ropes, a first strand of traction ropes is connected between the third rope loop and the first rope loop through a snap joint, a second strand of traction ropes is connected between the fifth rope loop and the third rope loop through a snap joint, and a third strand of traction ropes is connected between the sixth rope loop and the fifth rope loop through a snap joint; and
the pontoon apparatus positioning step includes the following working procedures:
working procedure 1: a crane vessel hoists the first pontoon apparatus to the fourth pontoon apparatus to the sea at high tide, then an anchor boat tows the first pontoon apparatus to the fourth pontoon apparatus to to-be-mounted positions of the pipeline section, the first pontoon apparatus to the fourth pontoon apparatus are sequentially anchored and positioned from front to back at a certain spacing, and then, nylon ropes are connected between the first pontoon apparatus and the second pontoon apparatus, between the second pontoon apparatus and the third pontoon apparatus, and between the third pontoon apparatus and the fourth pontoon apparatus respectively; and
working procedure 2: a plurality of buoys are tied at front inner corners and rear inner corners of two pontoon bodies of each of the first pontoon apparatus to the fourth pontoon apparatus respectively; and
the construction process includes the following steps:
step 1: two anchor boats tow one pipeline section, a front anchor boat pulls the pipeline head of the pipeline section through a cable, and a rear anchor boat controls the pipeline tail of the pipeline section through a cable and maintains the same speed as the front anchor boat; after the anchor boats are almost at a mounting region, the front anchor boat slowly slows down to a stop, and the rear anchor boat performs hovering of the pipeline section; and after the pipeline section is basically stopped and is close to the fourth pontoon apparatus, a small boat delivers the cable connected to the front anchor boat to the fourth pontoon apparatus, and the rear anchor boat always stabilizes the pipeline section at the rear before the pipeline section enters the first pontoon apparatus to the fourth pontoon apparatus;
step 2: the two anchor boats are stationed, and the small boat unties a rope head of the first strand of traction ropes connected to the first rope loop, delivers the rope head of the first strand of traction ropes to two traction winches on the fourth pontoon apparatus, and then unties the cable connected to the pipeline head of the pipeline section;
step 3: the two traction winches on the fourth pontoon apparatus pull the first strand of traction ropes, the pipeline section is led into a pipeline channel of the fourth pontoon apparatus until the pipeline head of the pipeline section is located in the middle of a pipeline channel of the third pontoon apparatus, then a rope head of the second strand of traction ropes connected to the third rope loop is untied, then two rope heads of the second strand of traction ropes are connected in one-to-one correspondence to the two traction winches on the fourth pontoon apparatus, and two rope heads of the first strand of traction ropes are untied at the same time;
step 4: the two traction winches on the fourth pontoon apparatus pull the second strand of traction ropes, the pipeline section continues to be led into a pipeline channel of the second pontoon apparatus from the pipeline channel of the third pontoon apparatus until the pipeline head of the pipeline section is located in the middle of a pipeline channel of the second pontoon apparatus, then a rope head of the third strand of traction ropes connected to the fifth rope loop is untied, then two rope heads of the third strand of traction ropes are connected in one-to-one correspondence to the two traction winches on the fourth pontoon apparatus, and two rope heads of the second strand of traction ropes are untied at the same time;
step 5: the two traction winches on the fourth pontoon apparatus pull the third strand of traction ropes, the pipeline section continues to be led into the pipeline channel of the second pontoon apparatus until the second rope loop on the pipeline section is located in the pipeline channel of the second pontoon apparatus, an operator on the second pontoon apparatus ties a rope tail of a fourth strand of traction ropes to the second rope loop, the nylon rope connected between the first pontoon apparatus and the second pontoon apparatus is inserted into snap joints of two rope heads of the fourth strand of traction ropes, then the operator on the second pontoon apparatus lifts the nylon rope and slides the two rope heads of the fourth strand of traction ropes onto the first pontoon apparatus, and then an operator on the first pontoon apparatus connects the two rope heads of the fourth strand of traction ropes to two traction winches on the first pontoon apparatus in one-to-one correspondence;
step 6: the two traction winches on the first pontoon apparatus pull the fourth strand of traction ropes, the pipeline head of the pipeline section is pulled to a mounting position, and then the cable connected between the pipeline tail of the pipeline section and the rear anchor boat is untied;
step 7: the operator on each pontoon apparatus ties one end of a short rope to a corresponding rope loop first, pulls the other end of the short rope, and then rotates the rope loop, to enable one end of the short rope to complete bottom support of the pipeline section with rotation of the rope loop; one end of the hoisting steel wire rope is connected to a lower hook below a movable pulley of one set of sheave blocks, the other end of the hoisting steel wire rope is connected to one end of the short rope, the other end of the hoisting steel wire rope is connected to a lower hook below a movable pulley of the other set of sheave blocks by pulling the other end of the short rope; and finally, the short rope is untied, to complete connecting the hoisting steel wire rope to the pipeline section;
step 8: the blind flanges at the two ends of the pipeline section are disassembled, which includes the following working procedures:
working procedure 1: a gangplank on the first pontoon apparatus and a gangplank on the fourth pontoon apparatus are unfolded first, and the operator stands on the gangplank of the first pontoon apparatus and the gangplank on the fourth pontoon apparatus and uses a pneumatic impact wrench to gradually disassemble, in one-to-one correspondence, bolts on the blind flanges at the two ends of the pipeline section from top to bottom;
working procedure 2: a steel wire rope on one traction winch on the first pontoon apparatus is hooked onto a lifting lug at the top of the blind flange at the front end of the pipeline section after bypassing one cross beam 22; and a steel wire rope on one traction winch on the fourth pontoon apparatus is hooked onto a lifting lug at the top of the blind flange at the rear end of the pipeline section after bypassing one cross beam;
working procedure 3: a hoisting steel wire rope on the first pontoon apparatus and a hoisting steel wire rope on the fourth pontoon apparatus are gradually lifted, to cooperate with the operator to disassemble the bolts on the blind flanges fixed at the two ends of the pipeline section;
working procedure 4: one traction winch on the first pontoon apparatus and one traction winch on the fourth pontoon apparatus move the two blind flanges to an outer side of the first pontoon apparatus and an outer side of the fourth pontoon apparatus in one-to-one correspondence for hanging, one buoy tied on the first pontoon apparatus and one buoy tied on the fourth pontoon apparatus are tied in one-to-one correspondence to the two blind flanges, to reduce the weight of the blind flanges, and the small boat recycles the two blind flanges at the subsequent high tide; and
working procedure 5: the plurality of buoys tied on the four pontoon apparatuses are tied on corresponding rope loops on the pipeline section first; and two hoisting winches on each of the four pontoon apparatuses lower a corresponding hoisting steel wire rope and gradually lower the pipeline section, an operator on the fourth pontoon apparatus disassembles the manhole sealing plate, and air in the pipeline section flows out through the manhole, so that the pipeline section is lowered horizontally;
step 9: the pipeline is measured, which includes measuring the following content:
content 1: accurate coordinates of a pipeline head are measured and a floating ball is tied after a previous pipeline section is mounted, a position of a pipeline head is pre-estimated when a latter pipeline section is mounted, and coordinates of the first pontoon apparatus are measured through a total station on the shore at the same time and are compared with the coordinates of the position of the pipeline head of the mounted previous pipeline section, to adjust a mounting position of the first pontoon apparatus;
content 2: a level gauge is disposed in an axial direction of the sea outfall pipeline on the shore, hoisting steel wire ropes on the same sides on the four pontoon apparatuses are observed, and by fine-tuning anchor ropes of the four pontoon apparatuses, it is ensured that the hoisting steel wire ropes on the same sides on the four pontoon apparatuses are located on the same vertical surface; and
content 3: a placement depth of the pipeline section is measured through a sounding lead, and a lowering length of the hoisting steel wire rope is adjusted; and
step 10: after the pipeline section is lowered to be close to the bottom of the foundation trench, a diver directs to insert a male flange at the head of the pipeline section into a female flange at the tail of the mounted previous pipeline section, and the diver locks a flange bolt between the flange ring and the female flange.

According to the above mounting method for a sea outfall pipeline in a shallow section, the hoisting support further includes two pairs of diagonal support bars; and each pair of diagonal support bars is connected in one-to-one correspondence between a top front side surface of the steel column and a front end top surface of a corresponding pontoon body and between a top rear side surface of the steel column and a rear end top surface of a corresponding pontoon body.

According to the above mounting method for a sea outfall pipeline in a shallow section, one end of the gangplank is mounted on an inner side of the rear top surface of one pontoon body through a pin shaft, and the other end of the gangplank is mounted on an inner side of the rear top surface of the other pontoon body through a positioning pin.

According to the above mounting method for a sea outfall pipeline in a shallow section, the construction process further includes:
step 11: inspection is performed after mounting: a locking condition of the flange bolt is inspected through an underwater camera, a joint sealing condition in the pipeline is captured through the manhole, and after it is ensured that a design requirement is met, a hook of the hoisting steel wire rope is released; and
step 12: processing is performed after mounting: after each pipeline section is mounted, a lead weight or a vertical rod is lowered on the first pontoon apparatus and is placed at the pipeline head of the pipeline section by the diver, the coordinates of the pipeline head are measured by the total station on the shore, and at the same time, the diver ties the floating ball to the pipeline head.

The mounting method for a sea outfall pipeline in a shallow section of this disclosure has the following features: a shallow-draft anchor boat is used for towing the pipeline section, and the four specially-made pontoon apparatuses are used for mounting the pipeline section within the pre-excavated foundation trench in the shallows, so that the difficulty in mounting the sea outfall pipeline in a long-distance shallow section can be effectively solved, and the impact on the nearby sea areas is reduced; meanwhile, by reducing the weight of the pipeline section, the pipeline section is always in a floating stability state, thereby ensuring the structural safety of the pontoon apparatuses; and there is no need for a companion ship, the blind flanges at the two ends of the pipeline section can be disassembled, which not only saves time and effort and saves construction costs, but also greatly reduces damage to the pipeline and ensures the quality during underwater mounting of the pipeline.

### BRIEF DESCRIPTION OF THE DRAWINGS

FIG. 1 is a front view of a pontoon apparatus used in a mounting method for a sea outfall pipeline in a shallow section according to this disclosure;

FIG. 2 is a side view of FIG. 1;

FIG. 3 is a top view of FIG. 2;

FIG. 4 is a schematic diagram of performing working procedure 1 of a pipeline pre-submergence preparation step in a preparation process according to this disclosure;

FIG. 5 is a schematic diagram of performing working procedure 2 of a pipeline pre-submergence preparation step in a preparation process according to this disclosure;

FIG. 6 is a schematic diagram of performing working procedure 4 of a pipeline pre-submergence preparation step in a preparation process according to this disclosure;

FIG. 7 is a schematic diagram of performing working procedure 1 of a pontoon apparatus positioning step in a preparation process according to this disclosure;

FIG. 8 is a schematic diagram of performing step 1 in a construction process according to this disclosure;

FIG. 9 is a schematic diagram of performing step 2 in a construction process according to this disclosure;

FIG. 10 is a schematic diagram of performing step 3 in a construction process according to this disclosure;

FIG. 11 is a schematic diagram of performing step 4 in a construction process according to this disclosure;

FIG. 12 is a schematic diagram of performing step 5 in a construction process according to this disclosure;

FIG. 13 is a schematic diagram of performing step 6 in a construction process according to this disclosure; and

FIG. 14 is a schematic diagram of performing step 7 in a construction process according to this disclosure.

### DETAILED DESCRIPTION OF THE EMBODIMENTS

This disclosure is further described below with reference to the accompanying drawings.

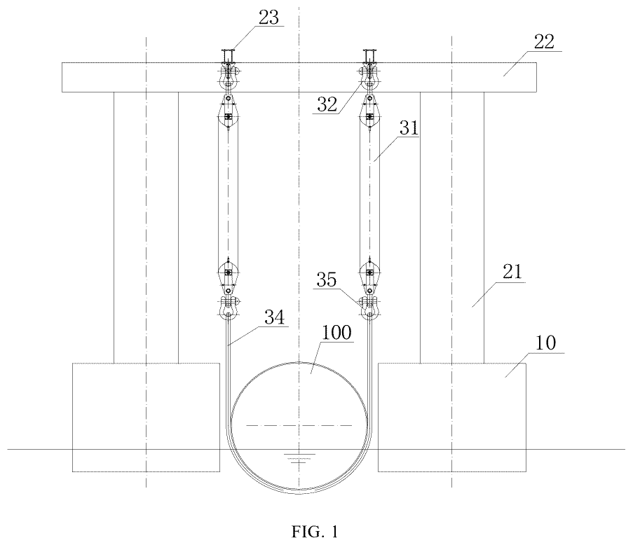

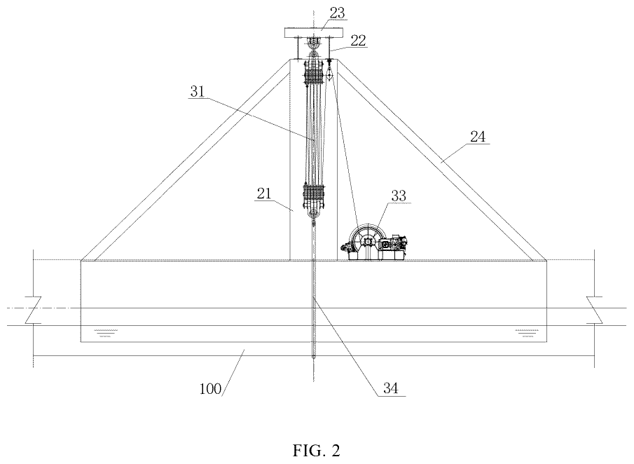

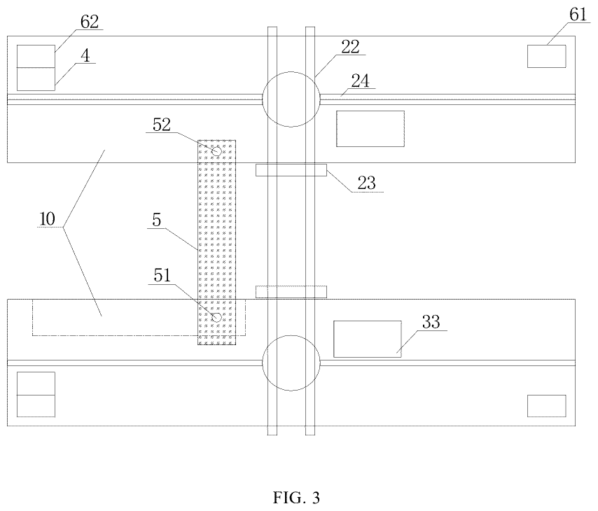

Referring to FIG. 1 to FIG. 3, a mounting method for a sea outfall pipeline in a shallow section of this disclosure uses four pontoon apparatuses to assemble a plurality of pipeline sections 100 into the sea outfall pipeline in the shallow section in a pre-excavated foundation trench in the shallows.

Each pontoon apparatus includes two pontoon bodies 10, a hoisting support, a spreader, two traction winches 4, a gangplank 5, two front anchor windlasses 61, and two rear anchor windlasses 62.

The two pontoon bodies 10 are disposed in parallel at a spacing greater than the diameter of the sea outfall pipeline, so that there is a pipeline channel between the two pontoon bodies 10, and the width of the pipeline channel is 3 m. A cross section of each pontoon body 10 is a rectangle with length×width=2.8 m×2.2 m, and the length of each pontoon body 10 is 12 m.

The hoisting support includes two steel columns 21, two cross beams 22, two longitudinal beams 23, and two pairs of diagonal support bars 24. The two steel columns 21 are fixed in one-to-one correspondence to the middles of top surfaces of the two pontoon bodies 10, and the steel column 21 adopts a steel pipe with an inner diameter of 1.22 m and a length of 5.5 m. The two cross beams 22 are connected across top surfaces of the two steel columns 21 in a spaced manner, a spacing between the two cross beams 22 is 0.8 m, and the cross beam 22 adopts H-shaped steel. The two longitudinal beams 23 are connected across the middles of top surfaces of the two cross beams 22, a spacing between the two longitudinal beams 23 is adapted to the diameter of the sea outfall pipeline 100, and the longitudinal beam 23 adopts double I-shaped steel. Each pair of diagonal support bars 24 is connected in one-to-one correspondence between a top front side surface of the steel column 21 and a front end top surface of a corresponding pontoon body 10 and between a top rear side surface of the steel column 21 and a rear end top surface of a corresponding pontoon body 10.

The spreader includes two sets of sheave blocks 31, two hoisting winches 33, and one hoisting steel wire rope 34. Fixed pulleys of the two sets of sheave blocks 31 are suspended in one-to-one correspondence on the middles of bottom surfaces of the two longitudinal beams 23 of the hoisting support respectively through upper hooks 32 above the fixed pulleys. The two hoisting winches 33 are mounted in one-to-one correspondence on the top surfaces of the two pontoon bodies 10, and free ends of steel wire ropes on the two hoisting winches 33 are connected in one-to-one correspondence to free ends of ropes wound on the two sets of sheave blocks 31. Two ends of the hoisting steel wire rope 34 are connected in one-to-one correspondence to lower hooks 35 below movable pulleys of the two sets of sheave blocks 31.

The two traction winches 4 are mounted in one-to-one correspondence on rear top surfaces of the two pontoon bodies 10.

The gangplank 5 is connected across the rear top surfaces of the two pontoon bodies 10. One end of the gangplank 5 is mounted on an inner side of the rear top surface of one pontoon body 10 through a pin shaft 51, so that the gangplank 5 can rotate around the pin shaft 51. The other end of the gangplank 5 is mounted on an inner side of the rear top surface of the other pontoon body 10 through a positioning pin 52.

The two front anchor windlasses 61 are mounted in one-to-one correspondence on front top surfaces of the two pontoon bodies 10 and are connected in one-to-one correspondence to two front anchors.

The two rear anchor windlasses 62 are mounted in one-to-one correspondence on the rear top surfaces of the two pontoon bodies 10 and are connected in one-to-one correspondence to two rear anchors.

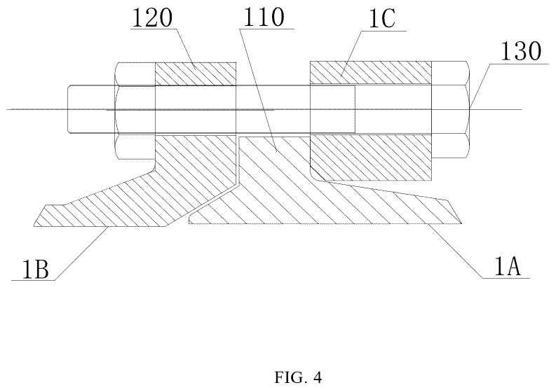

Referring to FIG. 4 to FIG. 14, the mounting method for a sea outfall pipeline in a shallow section of this disclosure includes a preparation process and a construction process.

The preparation process includes a pipeline pre-submergence preparation step and a pontoon apparatus positioning step.

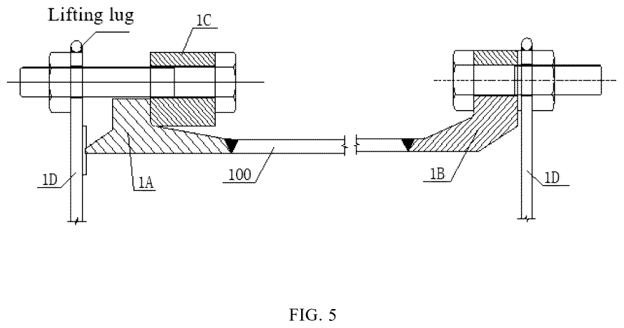

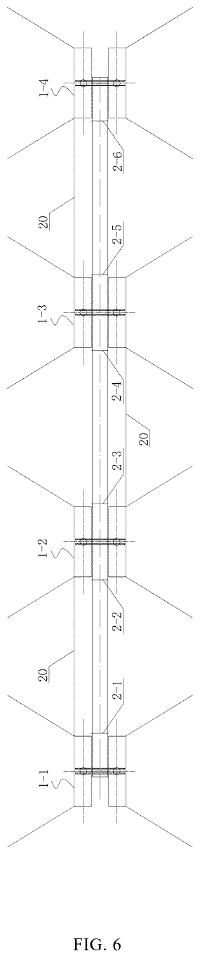

The pipeline pre-submergence preparation step performs and includes the following working procedures in a pipeline assembling site:
working procedure 1: a male flange 1A and a female flange 1B are fixed in one-to-one correspondence at a pipeline head and a pipeline tail of each pipeline section 100; a convex-ridge ring 110 extends radially from an outer end surface of a docked end of the male flange 1A with the female flange 1B; a connection plate 120 extends radially from an outer circumferential surface of a docked end of the female flange 1B with the male flange 1A, and a plurality of connection holes are radially and uniformly distributed on a surface of the connection plate 120; and after a tenon of the male flange 1A is inserted into a tenon groove of the female flange 1B, the male flange 1A and the female flange 1B are fastened through a flange ring 1C disposed on a rear end surface of the convex-ridge ring 110 and a plurality of sets of bolt assemblies 130 disposed in one-to-one correspondence between a plurality of bolt holes on the flange ring 1C and the plurality of connection holes on the connection plate 120 (referring to FIG. 4);
working procedure 2: a blind flange 1D is mounted on an outer end surface of the female flange 1B of each pipeline section 100, and a blind flange 1D is also mounted on an outer end surface of the male flange 1A of each pipeline section 100 through the flange ring 1C (referring to FIG. 5);
working procedure 3: a manhole is formed at a position, close to the flange, of a seaward end of each pipeline section 100, and a manhole sealing plate is used for sealing the manhole, to facilitate inspection, processing, and subsequent maintenance after the pipeline is mounted; and
working procedure 4: a first rope loop 2-1 to a sixth rope loop 2-6 are tied to each pipeline section 100 along a length direction, the first rope loop 2-1 is 0.5 m away from a rear end of a first pontoon apparatus 1-1, the second rope loop 2-2 and the third rope loop 2-3 are 0.5 m away from a front end and a rear end of a second pontoon apparatus 1-2 in one-to-one correspondence, the fourth rope loop 2-4 and the fifth rope loop 2-5 are 0.5 m away from a front end and a rear end of a third pontoon apparatus 1-3 in one-to-one correspondence, and the sixth rope loop 2-6 is 0.5 m away from a front end of a fourth pontoon apparatus 1-4, so that an operator can conveniently tie a buoy to the pipeline section 100 on the first pontoon apparatus 1-1 to the fourth pontoon apparatus 1-4; shackles facilitating underwater removal by a diver are disposed at the tops of the first rope loop to the sixth rope loop and on the same horizontal line as the manhole sealing plate respectively; and finally, three strands of traction ropes are tied on each pipeline section 100, each strand of traction ropes is composed of two traction ropes, a first strand of traction ropes 3-1 is connected between the third rope loop 2-3 and the first rope loop 2-1 through a snap joint, a second strand of traction ropes 3-2 is connected between the fifth rope loop 2-5 and the third rope loop 2-3 through a snap joint, and a third strand of traction ropes 3-3 is connected between the sixth rope loop 2-6 and the fifth rope loop 2-5 through a snap joint (referring to FIG. 6).

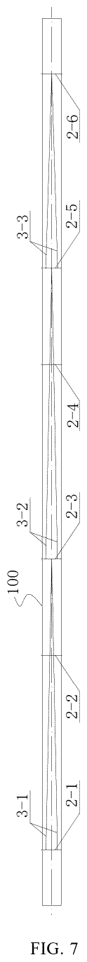

The pontoon apparatus positioning step includes the following working procedures:
working procedure 1: a crane vessel hoists the first pontoon apparatus to the fourth pontoon apparatus to the sea at high tide, then an anchor boat tows the first pontoon apparatus 1-1 to the fourth pontoon apparatus 1-4 to to-be-mounted positions of the pipeline section, the first pontoon apparatus 1-1 to the fourth pontoon apparatus 1-4 are sequentially anchored and positioned from front to back at a certain spacing, and positions of the first pontoon apparatus to the fourth pontoon apparatus are adjusted through two front anchor windlasses 61 and two rear anchor windlasses 62 on each of the first pontoon apparatus to the fourth pontoon apparatus; when some soil cannot be anchored and fixed, a prefabricated concrete block can be lowered into the water by a hook disposed on the anchor boat at high tide to serve as a fixed anchor; the first pontoon apparatus 1-1 and the fourth pontoon apparatus 1-4 are used in one-to-one correspondence for disassembling the blind flanges at two ends of the pipeline section, and the second pontoon apparatus 1-2 and the third pontoon apparatus 1-3 are used for mounting the pipeline section; and then, nylon ropes 20 are connected between the first pontoon apparatus 1-1 and the second pontoon apparatus 1-2, between the second pontoon apparatus 1-2 and the third pontoon apparatus 1-3, and between the third pontoon apparatus 1-3 and the fourth pontoon apparatus 1-4 respectively, to increase the integrity of the first pontoon apparatus 1-1 to the fourth pontoon apparatus 1-4 (referring to FIG. 7); and
working procedure 2: a plurality of buoys are tied at front inner corners and rear inner corners of two pontoon bodies 10 of the first pontoon apparatus 1-1 to front inner corners and rear inner corners of two pontoon bodies 10 of the fourth pontoon apparatus 1-4 respectively (not shown in the figure).

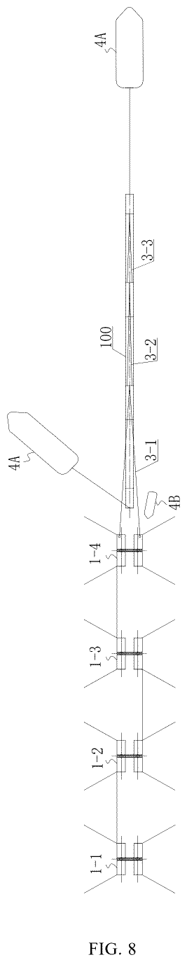

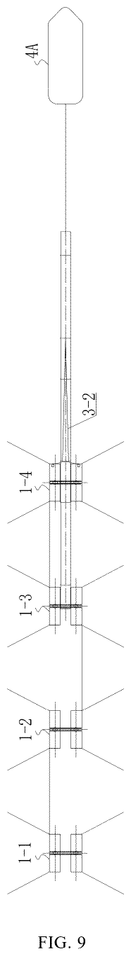

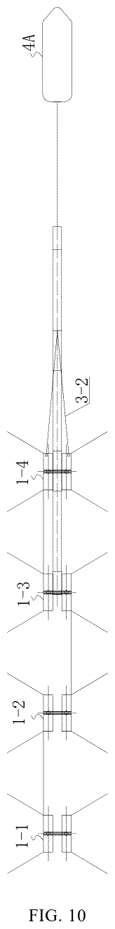

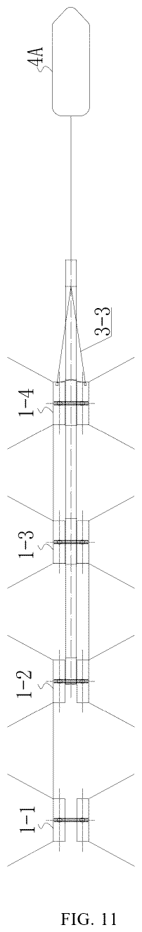

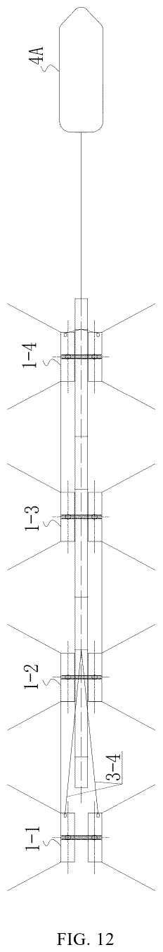

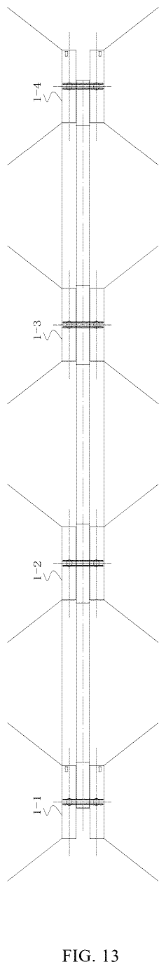

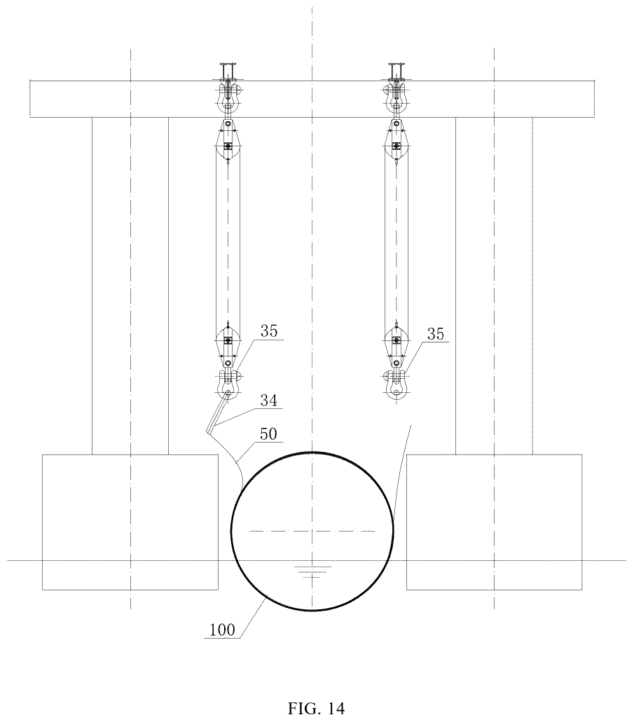

The construction process includes the following steps:
step 1: two anchor boats or powered vessels tow one pipeline section 100, a front anchor boat 4A pulls the pipeline head of the pipeline section 100 through a cable, and a rear anchor boat 4A controls the pipeline tail of the pipeline section 100 through a cable, maintains the same speed as the front anchor boat 4A, and is used for braking and hovering at a critical moment; when the anchor boats are almost at a mounting region, the front anchor boat 4A slowly slows down to a stop, and the rear anchor boat 4A performs hovering of the pipeline section 100; and after the pipeline section 100 is basically stopped and is close to the fourth pontoon apparatus 1-4, a small boat 4B delivers the cable connected to the front anchor boat 4A to the fourth pontoon apparatus 1-4, the front anchor boat 4A can leave, and the rear anchor boat 4A always stabilizes the pipeline section 100 at the rear before the pipeline section 100 enters the first pontoon apparatus to the fourth pontoon apparatus (referring to FIG. 8);
step 2: the two anchor boats 4A are stationed, and the small boat 4B unties a rope head of the first strand of traction ropes 3-1 connected to the first rope loop 2-1, delivers the rope head of the first strand of traction ropes 3-1 to two traction winches 4 on the fourth pontoon apparatus 1-4, and then unties the cable connected to the pipeline head of the pipeline section 100 (referring to FIG. 9);
step 3: the two traction winches 4 on the fourth pontoon apparatus 1-4 pull the first strand of traction ropes 3-1, the pipeline section 100 is led into a pipeline channel of the fourth pontoon apparatus 1-4 until the pipeline head of the pipeline section 100 is located in the middle of a pipeline channel of the third pontoon apparatus 1-3, then a rope head of the second strand of traction ropes 3-2 connected to the third rope loop 2-3 is untied, then two rope heads of the second strand of traction ropes 3-2 are connected in one-to-one correspondence to the two traction winches 4 on the fourth pontoon apparatus 1-4, and two rope heads of the first strand of traction ropes 3-1 are untied at the same time (referring to FIG. 10);
step 4: the two traction winches 4 on the fourth pontoon apparatus 1-4 pull the second strand of traction ropes 3-2, the pipeline section 100 continues to be led into a pipeline channel of the second pontoon apparatus 1-2 from the pipeline channel of the third pontoon apparatus 1-3 until the pipeline head of the pipeline section 100 is located in the middle of a pipeline channel of the second pontoon apparatus 1-2, then a rope head of the third strand of traction ropes 3-3 connected to the fifth rope loop 2-5 is untied, then two rope heads of the third strand of traction ropes 3-3 are connected in one-to-one correspondence to the two traction winches 4 on the fourth pontoon apparatus 1-4, and two rope heads of the second strand of traction ropes 3-2 are untied at the same time (referring to FIG. 11);
step 5: the two traction winches 4 on the fourth pontoon apparatus 1-4 pull the third strand of traction ropes 3-3, the pipeline section 100 continues to be led into the pipeline channel of the second pontoon apparatus 1-2 until the second rope loop 2-2 on the pipeline section 100 is located in the pipeline channel of the second pontoon apparatus 1-2, an operator on the second pontoon apparatus 1-2 ties a rope tail of a fourth strand of traction ropes 3-4 to the second rope loop 2-2, the nylon rope 20 connected between the first pontoon apparatus 1-1 and the second pontoon apparatus 1-2 is inserted into snap joints of two rope heads of the fourth strand of traction ropes 3-4, then the operator on the second pontoon apparatus 1-2 lifts the nylon rope 20 and slides the two rope heads of the fourth strand of traction ropes 3-4 onto the first pontoon apparatus 1-1, and then an operator on the first pontoon apparatus 1-1 connects the two rope heads of the fourth strand of traction ropes 3-4 to two traction winches 4 on the first pontoon apparatus 1-1 in one-to-one correspondence (referring to FIG. 12);
step 6: the two traction winches 4 on the first pontoon apparatus 1-1 pull the fourth strand of traction ropes 3-4, the pipeline head of the pipeline section 100 is pulled to a mounting position, and then the cable connected between the pipeline tail of the pipeline section 100 and the rear anchor boat 4A is untied (referring to FIG. 13);
step 7: the operator on the first pontoon apparatus 1-1 ties one end of a short rope 50 to the first rope loop 2-1 first, pulls the other end of the short rope 50, and then rotates the first rope loop 2-1, to enable one end of the short rope 50 to complete the bottom support of the pipeline section 100 with the rotation of the first rope loop 2-1; one end of the hoisting steel wire rope 34 on the first pontoon apparatus 1-1 is connected to a lower hook below a movable pulley of one set of sheave blocks 31, the other end of the hoisting steel wire rope 34 is connected to one end of the short rope 50, the other end of the hoisting steel wire rope 34 is connected to a lower hook below a movable pulley of the other set of sheave blocks 31 by pulling the other end of the short rope 50, and finally, the short rope 50 is untied, to complete connecting the hoisting steel wire rope 34 on the first pontoon apparatus 1-1 to the pipeline section 100 (referring to FIG. 14); and similarly, operators on the second pontoon apparatus 1-2, the third pontoon apparatus 1-3, and the fourth pontoon apparatus 1-4 connect respective hoisting steel wire ropes 34 to the pipeline section 100;
step 8: the blind flanges at the two ends of the pipeline section are disassembled, which includes the following working procedures:
working procedure 1: a gangplank 5 on the first pontoon apparatus 1-1 and a gangplank 5 on the fourth pontoon apparatus 1-4 are unfolded first, and the operator stands on the gangplank 5 of the first pontoon apparatus 1-1 and the gangplank 5 on the fourth pontoon apparatus 1-4 and uses a pneumatic impact wrench to gradually disassemble, in one-to-one correspondence, bolts on the blind flanges 1D at the two ends of the pipeline section 100 from top to bottom;
working procedure 2: a steel wire rope on one traction winch 4 on the first pontoon apparatus 1-1 is hooked onto a lifting lug at the top of the blind flange 1D at the front end of the pipeline section 100 after bypassing one cross beam 22; and a steel wire rope on one traction winch 4 on the fourth pontoon apparatus 1-4 is hooked onto a lifting lug at the top of the blind flange 1D at the rear end of the pipeline section 100 after bypassing one cross beam 22;
working procedure 3: the hoisting steel wire rope 34 on the first pontoon apparatus 1-1 and the hoisting steel wire rope 34 on the fourth pontoon apparatus 1-4 are gradually lifted, to cooperate with the operator to disassemble the bolts on the blind flanges 1D fixed at the two ends of the pipeline section 100;
working procedure 4: one traction winch 4 on the first pontoon apparatus 1-1 and one traction winch 4 on the fourth pontoon apparatus 1-4 move the two blind flanges 1D to an outer side of the first pontoon apparatus 1-1 and an outer side of the fourth pontoon apparatus 1-4 in one-to-one correspondence for hanging, one buoy tied on the first pontoon apparatus 1-1 and one buoy tied on the fourth pontoon apparatus 1-4 are tied in one-to-one correspondence to the two blind flanges 1D, to reduce the weight of the blind flanges 1D, and the small boat recycles the two blind flanges 1D at the subsequent high tide; and
working procedure 5: the plurality of buoys tied on the four pontoon apparatuses are tied on corresponding rope loops on the pipeline section 100 first, to reduce the weight of the pipeline section 100 after entering the water, so that the pipeline section 100 is close to a floating stable state, thereby reducing the pressure of anchor ropes of the pontoon apparatuses when the pipeline section 100 moves in a horizontal direction; at the same time, the buoys should be slightly heavier, which is convenient for the pontoon apparatuses to adjust the position of the pipeline section up and down through spreaders, so as to facilitate the alignment of the pipeline section; and then, two hoisting winches 33 on each of the four pontoon apparatuses lower a corresponding hoisting steel wire rope 34 and gradually lower the pipeline section 100, the operator on the fourth pontoon apparatus 1-4 disassembles the manhole sealing plate, and air in the pipeline section 100 flows out through the manhole, so that the pipeline section 100 is lowered horizontally;
step 9: the pipeline is measured, which includes measuring the following content:
content 1: accurate coordinates of a pipeline head are measured and a floating ball is tied after a previous pipeline section is mounted, a position of a pipeline head is pre-estimated when a latter pipeline section is mounted, and coordinates of the first pontoon apparatus are measured through a total station on the shore at the same time and are compared with the coordinates of the position of the pipeline head of the mounted previous pipeline section, to adjust a mounting position of the first pontoon apparatus;
content 2: a level gauge is disposed in an axial direction of the sea outfall pipeline on the shore, hoisting steel wire ropes on the same sides on the four pontoon apparatuses are observed, and by fine-tuning the anchor ropes of the four pontoon apparatuses, it is ensured that the hoisting steel wire ropes on the same sides on the four pontoon apparatuses are located on the same vertical surface; and
content 3: a placement depth of the pipeline section is measured through a sounding lead, and a lowering length of the hoisting steel wire rope is adjusted;
step 10: after the pipeline section is lowered to be close to the bottom of the foundation trench, the diver directs to insert a male flange at the head of the pipeline section into a female flange at the tail of the mounted previous pipeline section, and the diver locks a flange bolt between the flange ring and the female flange;
step 11: inspection is performed after mounting: a locking condition of the flange bolt is inspected through an underwater camera, a joint sealing condition in the pipeline is captured through the manhole, and after it is ensured that a design requirement is met, a hook of the hoisting steel wire rope is released; and
step 12: processing is performed after mounting: after each pipeline section is mounted, a lead weight or a vertical rod is lowered on the first pontoon apparatus and is placed at the pipeline head of the pipeline section by the diver, the coordinates of the pipeline head are measured by the total station on the shore, and at the same time, the diver ties the floating ball to the pipeline head.

The above embodiments are only used to illustrate this disclosure rather than to limit this disclosure. Those skilled in the art may make various changes or variations without departing from the spirit and scope of this disclosure. Therefore, all equivalent technical solutions should also fall within the scope of this disclosure and should be defined by the claims.

What is claimed is:

1. A mounting method for a sea outfall pipeline in a shallow section, wherein four pontoon apparatuses are used for assembling a plurality of pipeline sections into the sea outfall pipeline in the shallow section in a pre-excavated foundation trench in the shallow section; and
each of the pontoon apparatuses comprises two pontoon bodies, a hoisting support, a spreader, two traction winches, a gangplank, two front anchor windlasses, and two rear anchor windlasses, wherein
the two pontoon bodies are disposed in parallel at a spacing greater than a diameter of the sea outfall pipeline, so that there is a pipeline channel between the two pontoon bodies;
the hoisting support comprises two steel columns, two cross beams, and two longitudinal beams; the two steel columns are fixed in one-to-one correspondence to the middles of top surfaces of the two pontoon bodies; the two cross beams are connected across top surfaces of the two steel columns in a spaced manner: and the two longitudinal beams are connected across the middles of top surfaces of the two cross beams, and a spacing between the two longitudinal beams is adapted to the diameter of the sea outfall pipeline;
the spreader comprises two sets of sheave blocks, two hoisting winches, and one hoisting steel wire rope; fixed pulleys of the two sets of sheave blocks are suspended in one-to-one correspondence on the middles of bottom surfaces of the two longitudinal beams of the hoisting support respectively through upper hooks above the fixed pulleys; the two hoisting winches are mounted in one-to-one correspondence on the top surfaces of the two pontoon bodies, and free ends of steel wire ropes on the two hoisting winches are connected in one-to-one correspondence to free ends of ropes wound on the two sets of sheave blocks; and
two ends of the hoisting steel wire rope are connected in one-to-one correspondence to lower hooks below movable pulleys of the two sets of sheave blocks;
the two traction winches are mounted in one-to-one correspondence on rear top surfaces of the two pontoon bodies;
the gangplank is connected across the rear top surfaces of the two pontoon bodies;
the two front anchor windlasses are mounted in one-to-one correspondence on front top surfaces of the two pontoon bodies and are connected in one-to-one correspondence to two front anchors; and
the two rear anchor windlasses are mounted in one-to-one correspondence on the rear top surfaces of the two pontoon bodies and are connected in one-to-one correspondence to two rear anchors; and
the mounting method comprises a preparation process and a construction process, wherein
the preparation process comprises a pipeline pre-submergence preparation step and a pontoon apparatus positioning step;
the pipeline pre-submergence preparation step performs and comprises the following working procedures in a pipeline assembling site:
working procedure 1: a male flange and a female flange are fixed in one-to-one correspondence at a pipeline head and a pipeline tail of each pipeline section; a convex-ridge ring extends radially from an outer end surface of a docked end of the male flange with the female flange; a connection plate extends radially from an outer circumferential surface of a docked end of the female flange with the male flange, and a plurality of connection holes are radially and uniformly distributed on a surface of the connection plate; and after a tenon of the male flange is inserted into a tenon groove of the female flange, the male flange and the female flange are fastened through a flange ring disposed on a rear end surface of the convex-ridge ring and a plurality of sets of bolt assemblies disposed in one-to-one correspondence between a plurality of bolt holes on the flange ring and the plurality of connection holes on the connection plate;
working procedure 2: a blind flange is mounted on an outer end surface of the female flange of each pipeline section, and a blind flange is also mounted on an outer end surface of the male flange of each pipeline section through the flange ring;
working procedure 3: a manhole is formed at a position, close to the flange, of a seaward end of each pipeline section, and a manhole sealing plate is used for sealing the manhole; and
working procedure 4: a first rope loop to a sixth rope loop are tied to each pipeline section along a length direction, the first rope loop is close to a rear end of a first pontoon apparatus, the second rope loop and the third rope loop are close to a front end and a rear end of a second pontoon apparatus in one-to-one correspondence, the fourth rope loop and the fifth rope loop are close to a front end and a rear end of a third pontoon apparatus in one-to-one correspondence, and the sixth rope loop is close to a front end of a fourth pontoon apparatus; and finally, three strands of traction ropes are tied on each pipeline section, each strand of traction ropes is composed of two traction ropes, a first strand of traction ropes is connected between the third rope loop and the first rope loop through a snap joint, a second strand of traction ropes is connected between the fifth rope loop and the third rope loop through a snap joint, and a third strand of traction ropes is connected between the sixth rope loop and the fifth rope loop through a snap joint; and
the pontoon apparatus positioning step comprises the following working procedures:
working procedure 1: a crane vessel hoists the first pontoon apparatus to the fourth pontoon apparatus to the sea at high tide, then an anchor boat tows the first pontoon apparatus to the fourth pontoon apparatus to to-be-mounted positions of the pipeline section, the first pontoon apparatus to the fourth pontoon apparatus are sequentially anchored and positioned from front to back at a certain spacing, and then, nylon ropes are connected between the first pontoon apparatus and the second pontoon apparatus, between the second pontoon apparatus and the third pontoon apparatus, and between the third pontoon apparatus and the fourth pontoon apparatus respectively; and
working procedure 2: a plurality of buoys are tied at front inner corners and rear inner corners of two pontoon bodies of each of the first pontoon apparatus to the fourth pontoon apparatus respectively; and
the construction process comprises the following steps:
step 1: two anchor boats tow one pipeline section, a front anchor boat pulls the pipeline head of the pipeline section through a cable, and a rear anchor boat controls the pipeline tail of the pipeline section through a cable and maintains the same speed as the front anchor boat; after the anchor boats are almost at a mounting region, the front anchor boat slowly slows down to a stop, and the rear anchor boat performs hovering of the pipeline section; and after the pipeline section is basically stopped and is close to the fourth pontoon apparatus, a small boat delivers the cable connected to the front anchor boat to the fourth pontoon apparatus, and the rear anchor boat always stabilizes the pipeline section at the rear before the pipeline section enters the first pontoon apparatus to the fourth pontoon apparatus;
step 2: the two anchor boats are stationed, and the small boat unties a rope head of the first strand of traction ropes connected to the first rope loop, delivers the rope head of the first strand of traction ropes to two traction winches on the fourth pontoon apparatus, and then unties the cable connected to the pipeline head of the pipeline section;
step 3: the two traction winches on the fourth pontoon apparatus pull the first strand of traction ropes, the pipeline section is led into a pipeline channel of the fourth pontoon apparatus until the pipeline head of the pipeline section is located in the middle of a pipeline channel of the third pontoon apparatus, then a rope head of the second strand of traction ropes connected to the third rope loop is untied, then two rope heads of the second strand of traction ropes are connected in one-to-one correspondence to the two traction winches on the fourth pontoon apparatus, and two rope heads of the first strand of traction ropes are untied at the same time;
step 4: the two traction winches on the fourth pontoon apparatus pull the second strand of traction ropes, the pipeline section continues to be led into a pipeline channel of the second pontoon apparatus from the pipeline channel of the third pontoon apparatus until the pipeline head of the pipeline section is located in the middle of a pipeline channel of the second pontoon apparatus, then a rope head of the third strand of traction ropes connected to the fifth rope loop is untied, then two rope heads of the third strand of traction ropes are connected in one-to-one correspondence to the two traction winches on the fourth pontoon apparatus, and two rope heads of the second strand of traction ropes are untied at the same time;
step 5: the two traction winches on the fourth pontoon apparatus pull the third strand of traction ropes, the pipeline section continues to be led into the pipeline channel of the second pontoon apparatus until the second rope loop on the pipeline section is located in the pipeline channel of the second pontoon apparatus, an operator on the second pontoon apparatus ties a rope tail of a fourth strand of traction ropes to the second rope loop, the nylon rope connected between the first pontoon apparatus and the second pontoon apparatus is inserted into snap joints of two rope heads of the fourth strand of traction ropes, then the operator on the second pontoon apparatus lifts the nylon rope and slides the two rope heads of the fourth strand of traction ropes onto the first pontoon apparatus, and then an operator on the first pontoon apparatus connects the two rope heads of the fourth strand of traction ropes to two traction winches on the first pontoon apparatus in one-to-one correspondence;
step 6: the two traction winches on the first pontoon apparatus pull the fourth strand of traction ropes, the pipeline head of the pipeline section is pulled to a mounting position, and then the cable connected between the pipeline tail of the pipeline section and the rear anchor boat is untied;
step 7: the operator on each pontoon apparatus tics one end of a short rope to a corresponding rope loop first, pulls the other end of the short rope, and then rotates the rope loop, to enable one end of the short rope to complete bottom support of the pipeline section with rotation of the rope loop; one end of the hoisting steel wire rope is connected to a lower hook below a movable pulley of one set of sheave blocks, the other end of the hoisting steel wire rope is connected to one end of the short rope, the other end of the hoisting steel wire rope is connected to a lower hook below a movable pulley of the other set of sheave blocks by pulling the other end of the short rope; and finally, the short rope is untied, to complete connecting the hoisting steel wire rope to the pipeline section;
step 8: the blind flanges at the two ends of the pipeline section are disassembled, which comprises the following working procedures:
working procedure 1: a gangplank on the first pontoon apparatus and a gangplank on the fourth pontoon apparatus are unfolded first, and the operator stands on the gangplank of the first pontoon apparatus and the gangplank on the fourth pontoon apparatus and uses a pneumatic impact wrench to gradually disassemble, in one-to-one correspondence, bolts on the blind flanges at the two ends of the pipeline section from top to bottom;
working procedure 2: a steel wire rope on one traction winch on the first pontoon apparatus is hooked onto a lifting lug at the top of the blind flange at the front end of the pipeline section after bypassing one cross beam; and a steel wire rope on one traction winch on the fourth pontoon apparatus is hooked onto a lifting lug at the top of the blind flange at the rear end of the pipeline section after bypassing one cross beam;
working procedure 3: a hoisting steel wire rope on the first pontoon apparatus and a hoisting steel wire rope on the fourth pontoon apparatus are gradually lifted, to cooperate with the operator to disassemble the bolts on the blind flanges fixed at the two ends of the pipeline section;
working procedure 4: one traction winch on the first pontoon apparatus and one traction winch on the fourth pontoon apparatus move the two blind flanges to an outer side of the first pontoon apparatus and an outer side of the fourth pontoon apparatus in one-to-one correspondence for hanging, one buoy tied on the first pontoon apparatus and one buoy tied on the fourth pontoon apparatus are tied in one-to-one correspondence to the two blind flanges, to reduce the weight of the blind flanges, and the small boat recycles the two blind flanges at the subsequent high tide; and
working procedure 5: the plurality of buoys tied on the four pontoon apparatuses are tied on corresponding rope loops on the pipeline section first; and
two hoisting winches on each of the four pontoon apparatuses lower a corresponding hoisting steel wire rope and gradually lower the pipeline section, an operator on the fourth pontoon apparatus disassembles the manhole sealing plate, and air in the pipeline section flows out through the manhole, so that the pipeline section is lowered horizontally;
step 9: the pipeline is measured, which comprises measuring the following content:
content 1: accurate coordinates of a pipeline head are measured and a floating ball is tied after a previous pipeline section is mounted, a position of a pipeline head is pre-estimated when a latter pipeline section is mounted, and coordinates of the first pontoon apparatus are measured through a total station on the shore at the same time and are compared with the coordinates of the position of the pipeline head of the mounted previous pipeline section, to adjust a mounting position of the first pontoon apparatus;
content 2: a level gauge is disposed in an axial direction of the sea outfall pipeline on the shore, hoisting steel wire ropes on the same sides on the four pontoon apparatuses are observed, and by fine-tuning anchor ropes of the four pontoon apparatuses, it is ensured that the hoisting steel wire ropes on the same sides on the four pontoon apparatuses are located on the same vertical surface; and
content 3: a placement depth of the pipeline section is measured through a sounding lead, and a lowering length of the hoisting steel wire rope is adjusted; and
step 10: after the pipeline section is lowered to be close to the bottom of the foundation trench, a diver directs to insert a male flange at the head of the pipeline section into a female flange at the tail of the mounted previous pipeline section, and the diver locks a flange bolt between the flange ring and the female flange.

2. The mounting method for a sea outfall pipeline in a shallow section according to claim 1, wherein the hoisting support further comprises two pairs of diagonal support bars; and each pair of diagonal support bars is connected in one-to-one correspondence between a top front side surface of the steel column and a front end top surface of a corresponding pontoon body and between a top rear side surface of the steel column and a rear end top surface of a corresponding pontoon body.

3. The mounting method for a sea outfall pipeline in a shallow section according to claim 1, wherein one end of the gangplank is mounted on an inner side of the rear top surface of one pontoon body through a pin shaft, and the other end of the gangplank is mounted on an inner side of the rear top surface of the other pontoon body through a positioning pin.

4. The mounting method for a sea outfall pipeline in a shallow section according to claim 1, wherein the construction process further comprises:
step 11: inspection is performed after mounting: a locking condition of the flange bolt is inspected through an underwater camera, a joint sealing condition in the pipeline is captured through the manhole, and after it is ensured that a design requirement is met, a hook of the hoisting steel wire rope is released: and
step 12: processing is performed after mounting: after each pipeline section is mounted, a lead weight or a vertical rod is lowered on the first pontoon apparatus and is placed at the pipeline head of the pipeline section by the diver, the coordinates of the pipeline head are measured by the total station on the shore, and at the same time, the diver ties the floating ball to the pipeline head.
